(19) United States
(12) Patent Application Publication
(10) Pub. No.: US 2013/0278130 A1
(43) Pub. Date: Oct. 24, 2013

(54) TEMPERATURE CONTROL OF ARC TUBE OF FLUORESCENT LAMP

(71) Applicants: Peter Lucz, Budapest (HU); Laszlo Bankuti, Budapest (HU); Karoly Talosi, Nagykanizsa (HU); Balazs Torok, Budapest (HU)

(72) Inventors: Peter Lucz, Budapest (HU); Laszlo Bankuti, Budapest (HU); Karoly Talosi, Nagykanizsa (HU); Balazs Torok, Budapest (HU)

(73) Assignee: General Electric Company, Schenectady, NY (US)

(21) Appl. No.: 13/453,177

(22) Filed: Apr. 23, 2012

(51) Int. Cl. H01J 61/52

(52) U.S. Cl. 313/17

(57) ABSTRACT

A fluorescent lamp includes an arc tube comprised of light transmissive material. The arc tube can be for a compact fluorescent lamp (CFL). A discharge sustaining fill, which may include mercury and an inert gas, is sealed in the interior of the arc tube. Electrodes are disposed in the sealed interior of the arc tube. An outer envelope is disposed around and spaced apart from the arc tube. The outer envelope can take the form of a conventional incandescent light bulb, candle, globe-shape or reflector shape. The outer envelope includes an opening. The arc tube includes a hollow protrusion that extends adjacent or into the opening. This can provide the arc tube with a lower temperature near the protrusion that can approximate the temperature of the outer envelope (a cold spot). This can regulate the vapor pressure of liquid (e.g., liquid mercury) in the arc tube.

### FIELD OF THE INVENTION

The present disclosure relates generally to a low pressure discharge lamp and more particularly to a compact fluorescent lamp in which mercury vapor pressure is controlled by a cold spot of the lamp.

### BACKGROUND OF THE INVENTION

Inside fluorescent lamps is a vacuum and mercury gas for producing light. When the lamp is turned on an electric arc is produced along the length of the lamp between the electrodes or cathodes at opposite ends of the lamp and liquid mercury is vaporized. The electrons collide with mercury atoms and charged atoms within the lamp and then ultraviolet photons are released. The photons interact with a phosphor coating on the lamp to produce visible light.

Compact fluorescent lamps (CFLs) have been used as replacements for incandescent lamps in industrial and home applications. CFLs are advantageous because they have low power consumption and a long lifetime. To maintain suitable luminous output and reduce the length of a CFL, specially designed arc tubes are used. Some examples of special CFL arc tube shapes include coiled tubes, spirals and fingers. Some CFLs known as décor lamps employ an outer bulb with an inner arc tube spaced apart from the outer bulb.

Internal mercury vapor pressure indicates the number of mercury molecules in the vapor phase. Only mercury vapor is involved in the radiation and light emitting process. There is an optimum mercury vapor pressure. When it is exceeded, additional mercury vapor molecules interfere with UV radiation. Rather than contacting the phosphor coating, some UV radiation will contact the excessive mercury molecules. Therefore, the lamp wall temperature can be controlled to maintain suitable lamp output and efficiency.

Vapor pressure of mercury can be controlled by the coldest spot on the arc tube. This “cold spot” of the arc tube is where the mercury condenses as a liquid. Usually in a compact fluorescent lamp, this is located at an end of the lamp furthest away from the electrodes. There is a fixed amount of mercury in the lamp. Thus, the amount of mercury condensed at the cold spot will control vapor pressure. The temperature of the arc tube at the cold spot will determine the amount of condensed mercury. When the arc tube is enclosed or in tightly closed or sealed fixtures, this can produce very hot lamp temperatures, leading to reduced efficiency and light output.

A wide variety of low-pressure discharge lamps are known in the art. These lamps contain small doses of mercury and the mercury radiates under the influence of a discharge arc. The mercury may be introduced into a discharge space of the lamp in a number of ways. One possible method is the introduction of a mercury vapor pressure controlling—amalgam, typically containing bismuth, e.g. a bismuth-indium-mercury compound. The other components of the amalgam besides mercury set up the working temperature of the amalgam. Every mercury-metal alloy is called an amalgam. The mercury necessary for the operation of the lamp is released from the amalgam.

Other methods of releasing mercury for operation of the lamp include liquid or pellet forms. The liquid and pellet are typically positioned and move freely in the arc tube. During operation the mercury “leaves the pellet” working similarly as with the liquid form. Pellet dosed lamps in which the pellet itself does not control mercury vapor pressure have a quick run up time of 20-40 seconds, for example. The mercury vapor pressure controlling—amalgam is optimally positioned in the exhaust tube close to the heat of the cathode as the operating temperature of the cathode is much higher than the liquid or pellet forms. This may result in a slow warm-up of the lamp because the amalgam must reach a much higher temperature from room temperature compared to the cold spot temperature for the liquid and pellet forms. Discharge lamps employing a mercury vapor pressure controlling—amalgam optimized for use in high temperature areas have the disadvantage of the longer start-up period than lamps using pure liquid mercury. The length of the start-up period is dependent on the speed at which mercury vapor pressure in the lamp increases. Additionally, the lumen output of the lamp is dependent on the mercury vapor pressure. The start-up period is longer for amalgam containing lamps since the mercury pressure is too low at lower temperatures usually present at start-up, typically in the range of 0° C. to about 50° C. The mercury vapor increases slowly, not reaching a desired level until the amalgam reaches higher temperatures. The mercury vapor pressure controlling—amalgam can maintain optimum mercury vapor pressure inside the arc tube but use of this amalgam, along with an auxiliary amalgam discussed below, leads to a long warm up time which, in some cases, can take as long as 60-180 seconds, causing low starting performance. In contrast, the mercury vapor pressure of a liquid mercury dosed lamp is much higher than the mercury vapor pressure of the amalgam containing lamp at the lower temperatures or at room temperature.

The amalgam which controls the mercury vapor pressure during lamp operation, except for the start-up period, is typically called the main amalgam. In contrast, an auxiliary amalgam influences the mercury vapor during the start-up period. That is, in order to improve start-up characteristics in an amalgam containing lamp, an auxiliary amalgam is typically attached to each cathode stem. Therefore, the auxiliary amalgam emits mercury during the start-up period. The auxiliary amalgam is heated by the cathode after ignition and emits mercury to make up for the lack of mercury vapor during the start-up period. A typical auxiliary amalgam is indium-mercury (In—Hg). During manufacturing, only an indium covered nickel plated steel mesh is inserted, which collects mercury only after the arctube is closed.

Lamps containing mercury vapor pressure controlling—amalgams have experienced varying degrees of success. Thus, a need exists for an improved low-pressure mercury vapor discharge lamp having improved warm-up characteristics.

### BRIEF DESCRIPTION OF THE INVENTION

One aspect of this disclosure features a fluorescent lamp including an arc tube comprised of light transmissive material. A discharge sustaining fill (e.g., including mercury or a mercury substitute and an inert gas) is sealed in the interior of the arc tube. Electrodes are disposed in the sealed interior of the arc tube. An outer envelope or bulb is disposed around and spaced apart from the arc tube. The outer envelope includes an opening. The arc tube includes a hollow protrusion or finger that extends adjacent or into the opening.

Referring to specific features of this disclosure, the positioning of the protrusion adjacent or into the opening of the outer envelope can provide the arc tube with a cold spot at the protrusion. The cold spot can be maintained at a temperature of less than 80° C. during operation of the lamp (e.g., 40-80° C.). The protrusion is hollow and has an interior surface that communicates with the interior surface of the arc tube. The protrusion may be tubular and may have an outer diameter that is ⅓ or less of a diameter of the arc tube. The protrusion can take on other shapes, for example, a spherical or globe like shape. The fill can comprise mercury or a mercury substitute and at least one inert gas selected from the group consisting of argon, krypton, neon and combinations thereof, for example. Both the arc tube and the protrusion may be comprised of glass. The protrusion and opening can be designed such that the protrusion touches or does not touch the outer envelope. The arc tube can include two or more of the protrusions or cams. The protrusions can be located at an end of the lamp most remote from the base or at other locations of the lamp. The arc tube can be that of a compact fluorescent lamp (CFL). That is, the discharge sustaining fill sealed along with the electrodes inside the arc tube forms a CFL. The outer envelope can be in a shape of a conventional incandescent light bulb, candle, globe, capsule, reflector or the like. The arc tube can be in a wide variety of shapes such as a spiral or fingers.

Another aspect of the invention features a compact fluorescent lamp including an arc tube comprised of glass. A discharge sustaining fill (e.g., including mercury or a mercury substitute and an inert gas) is sealed in the interior of the arc tube. Electrodes are disposed in the sealed interior of the arc tube. An outer envelope is disposed around and spaced apart from the arc tube. The outer envelope includes an opening and is in a shape of a conventional incandescent light bulb. The arc tube includes a hollow protrusion or finger comprised of glass which extends adjacent or into the opening. The positioning of the protrusion adjacent or into the opening of the outer envelope provides the arc tube with a cold spot at or along the protrusion. The vapor pressure of liquid mercury in the arc tube can be controlled by the cold spot. Any one or more of the specific features described above regarding the first aspect apply in any combination to this aspect of the disclosure.

Many additional features, advantages and a fuller understanding of the invention will be had from the accompanying drawings and the Detailed Description of the Invention that follows. It should be understood that the above Brief Description of the Invention describes the invention in broad terms while the following Detailed Description of the Invention describes the invention more narrowly and presents embodiments that should not be construed as necessary limitations of the broad invention as defined in the claims.

### BRIEF DESCRIPTION OF THE DRAWINGS

FIG. 1 is a perspective view of a lamp made according to this disclosure;

FIG. 2 is a partial cross-sectional view of the lamp of FIG. 1;

FIG. 3 is an enlarged cross-sectional view of the lamp of FIG. 2;

FIG. 4 is another lamp with a different arc tube than the lamp of FIG. 2;

FIG. 5 is a graph of runup time of two lamps made according to this disclosure or not, plotting luminous flux % versus time; and

FIGS. 6-9 are examples of lamps made according to this disclosure having various outer envelope shapes.

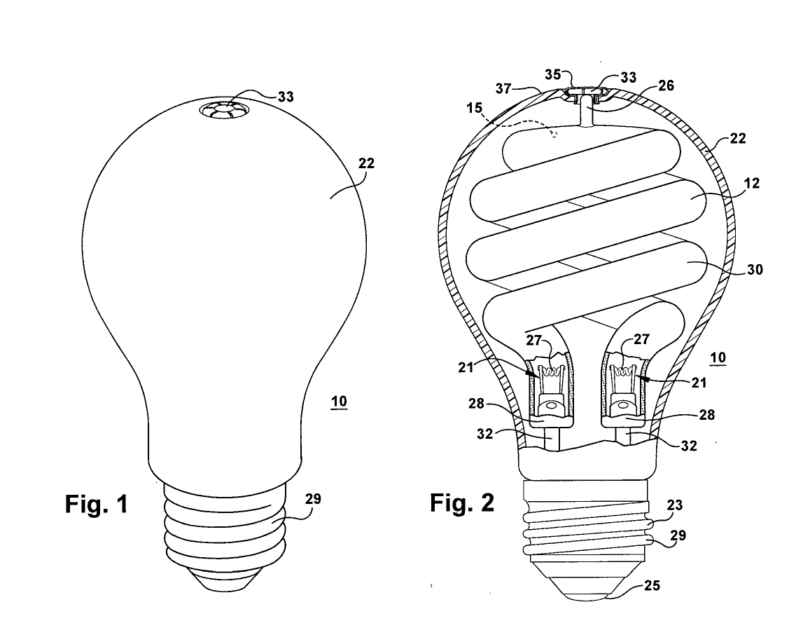

### DETAILED DESCRIPTION OF THE INVENTION

A fluorescent lamp 10 includes an arc tube 12 comprised of light transmissive material such as glass. An electrical discharge sustaining fill 14 including mercury or a mercury substitute and an inert gas is sealed in the interior region 16 of the arc tube. A dose of mercury containing alloy can be contained in a pellet 15 that alone does not control mercury vapor pressure. The arc tube has an interior surface 18 and an exterior surface 20. The arc tube 12 interior wall 18 encloses a sealed volume of the interior region 16 or discharge chamber. Electrodes 21 include filaments 27 that are disposed in the sealed interior 16 of the arc tube. The electrodes in the arc tube are electrically connected in a known manner to external electrical contacts 23, 25 at the base 28 of the lamp (FIG. 2). A phosphor layer coats an inside surface of the arc tube (not shown). The lamp is a décor style lamp having an outer envelope or bulb 22 comprised of light transmissive material such as glass disposed around and spaced apart from the arc tube 12. On the other hand, the outer envelope of bulb 22 could be a reflector.

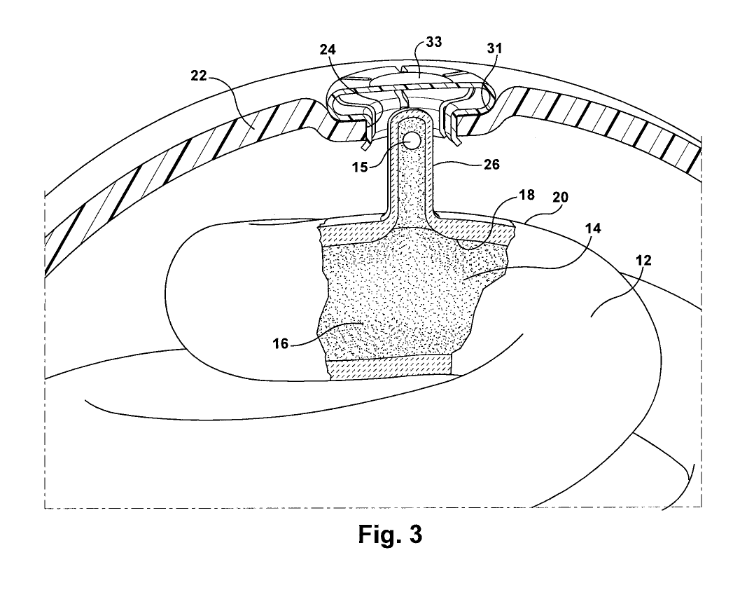

The outer envelope 22 includes an opening 24. A hollow protrusion or finger 26 extends from the arc tube 12 into the opening 24 (FIG. 3). The protrusion 26 can be formed of a light transmissive material such as glass. The protrusion 26 is located at a cold spot on the arc tube. The cold spot is formed when the base of the lamp is located above the arc tube such as when used for ceiling lighting. The lamp of the invention can operate when the base is up and the protrusion is at the bottom so liquid mercury can be collected in the protrusion. However, one or more protrusions can be disposed at various locations of the arc tube and the lamp might be positioned horizontally. A countersink depression 31 can be disposed around the opening 24. A cap 33 can fit into the opening 24 around the protrusion 26 into contact with the outer envelope 22. The cap 33 fits into the countersink 31 so that its outer surface 35 is flush with an outer surface 37 of the bulb 22.

The light transmissive sealed discharge tube or arc tube 12 can be formed of a material which is transmissive to radiation in the visible range and may also be transmissive to radiation in the IR range. Suitable materials for forming the arc tube 12 and envelope 22 include transparent materials such as quartz glass, and other vitreous materials, although translucent materials, such as ceramic materials, are also contemplated. As illustrated in FIG. 2, the arc tube 12 is a single tube with substantially straight end sections 28 and an intermediate portion 30 has a spiral configuration wound about a principal axis of the lamp to provide a substantially homogeneous illumination. At the end sections 28 of the arc tube path, the tube is provided with the electrodes or cathodes and lead-in wires extend through exhaust tubes 32 connected to the filaments. The lead-in wires of the discharge tube are connected to a ballast unit (not shown) for controlling the current in the discharge tubes.

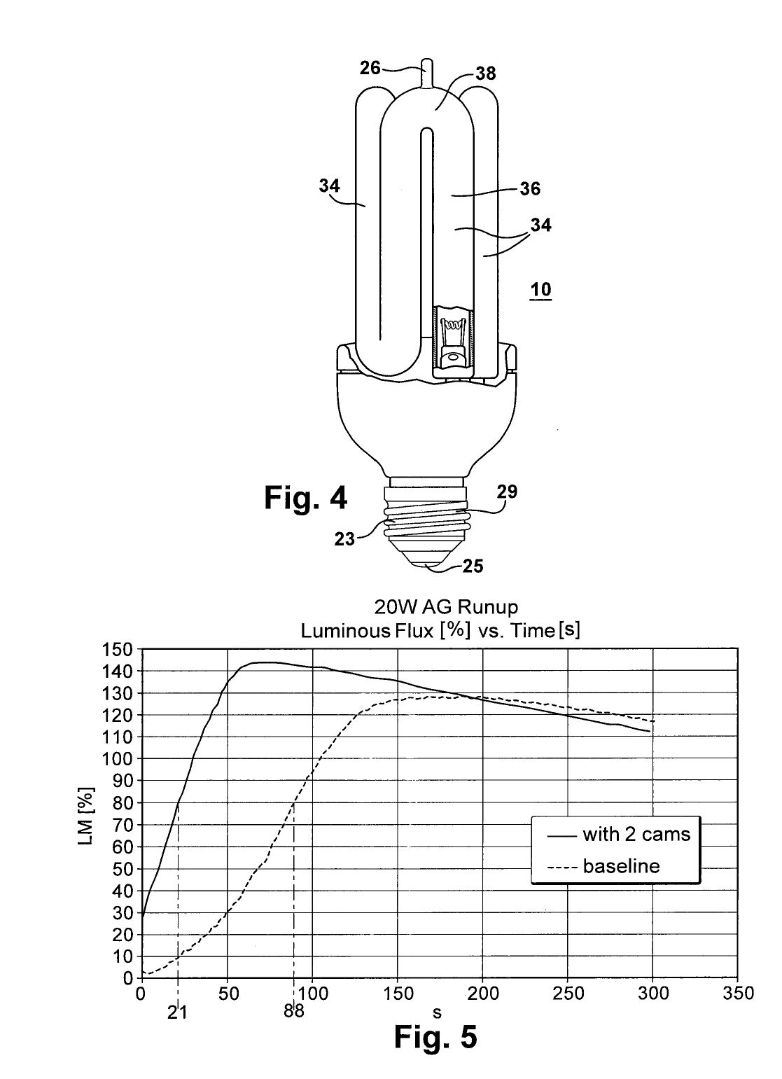

In another embodiment, the arc tube may be comprised of straight tube members with a longitudinal axis substantially parallel to the principal axis of the fluorescent lamp, in which the neighboring tube members are connected to each other in series to form a continuous arc path. In yet another embodiment, configurations may include two, four or six individual arc tube members depending on the required output luminous intensity. The arc tube arrangement may also comprise two individual, elongated discharge tube members 34 bent to a U-shape of substantially the same length, which are interconnected by a bridge to form a continuous arc path. Configurations may include one or three individual arc tubes bent in a U-shape depending on the required output luminous intensity shown in FIG. 4. The U-shaped arc tube members may comprise substantially parallel straight sections 36 defining the length of the arc tube arrangement and a curved middle section 38.

In order to provide visible light, the internal surface of the arc tubes is covered with the phosphor layer (not shown). This phosphor layer is within the sealed discharge volume. Examples of compositions of suitable phosphor layers are known. This phosphor layer converts the short wave, mainly UVC radiation into longer wave radiation in the spectrum of visible light. The phosphor layer is applied to the inner surface of the discharge tube before the tube is sealed.

The discharge sustaining fill includes, for example, an inert gas such as argon or a mixture of argon and other inert gases such as xenon, krypton, neon, and combinations thereof at a low pressure often in combination with a small quantity of mercury to provide a desired low vapor pressure operation of the lamp. This gas fill is responsible for the arc voltage (sets up the mean free path of the electrons).

The cold spot is located, for example, at a point of the arc tube that is farthest from the filaments of the electrodes. The cold spot on the arc tube can be maintained at a temperature that approximates the temperature of the outer envelope. The cold spot can be maintained at a temperature of not more than 80° C. during operation of the lamp (e.g., 40-80° C.). The cold spot temperature varies in different lamps due to different diameters of the arc tubes but would be apparent to one of ordinary skill in the art in view of this disclosure without undue experimentation.

The protrusion can have an interior that communicates with the interior of the arc tube. The protrusion may be tubular and have an outer diameter that is ⅓ or less of a diameter of the arc tube. The protrusion can also be formed of light transmissive material. For example, the arc tube, the protrusion and the outer envelope can be comprised of glass. The protrusion and the arc tube can be formed of the same glass composition, for example. The protrusion and the outer envelope and opening can be designed such that the protrusion does not touch the outer envelope. In this case, another opening may be formed in the outer envelope to permit air flow. Alternatively, the protrusion might touch the cap such as when a heat sink material is used for the cap. The protrusion can be formed by providing a separate tubular piece of glass having an opening on only one end, positioning the opening of the protrusion against an opening of similar diameter in the arc tube and then melting the glass together to join the protrusion to the arc tube. The cap can fit into the opening into contact with the outer envelope. The cap can be metal, plastic or a heat insulator.

The protrusion, being positioned in the opening in the outer envelope which is much cooler than the arc tube, is a cold spot of the arc tube. Liquid may condense from the vapor phase onto the coldest spot of a surface in the vapor. In this case, the protrusion becomes a cold spot of the arc tube in view of the heat transfer between the protrusion and outside of the outer envelope. Reference to the terms cold spot herein do not mean that the spot is actually cold but that it is relatively cooler than the remaining surfaces of the arc tube so that liquid mercury will condense from mercury vapor onto the cold spot. This will result in liquid collecting inside the protrusion. During the start up phase of operation, the mercury in the protrusion will go back into the vapor phase as the lamp starts up and through steady state operation.

If the system and ambient conditions allow the temperature of the cold spot to be around 40-80° C. then the vapor pressure of liquid mercury can be close to an optimum value. In this case liquid Hg or a mercury alloy containing pellet dropped in the arc tube can be used. This solution is used in most LFLs and non-décor, low wattage (<30 W) CFLs. An advantage is that Hg vapor pressure at 25° C. (turned off lamp) enables 40-60% of stabilized light output when the lamp is switched on; also full light output is reached within 30-120 seconds. A disadvantage is there is a tight ambient temperature range of maximum light output.

All mercury-metal alloys are called amalgam but in some terminology the “pellet” is used for those low temperature (high equilibrium vapor pressure) amalgams which are used for dosing Hg only, not for controlling vapor pressure. This solution is safer and also more accurate when a low amount of Hg is dosed. These types of pellets are suitable for use in this disclosure.

Referring to FIG. 5, the runup performance of two 20 W décor types of CFL lamps is shown. Both of the décor style lamps included a spiral shaped arc tube enclosed by an outer envelope in the shape of a conventional incandescent light bulb. One lamp included no protrusion for creating a cold spot on the arc tube and included mercury vapor pressure controlling—amalgam (bismuth indium mercury alloy) while the other included two protrusions or cams for creating cold spots on the arc tube according to this disclosure and was dosed with a mercury alloy containing pellet. The runup time is determined at a point where the luminous flux was at 80% of maximum luminous flux. It can be seen that the arc tube including the protrusions made according to this disclosure advantageously had a much faster runup time of 21 seconds compared to 88 seconds for the comparative lamp. The temperature of this protrusion can be low enough to control the Hg vapor pressure; no amalgam control is needed. The amalgam dosed lamps can have a long run up time while the pellet/liquid dosed have much better run ups. If the vapor pressure of the cold spot can be controlled then the pellet solution can be used. A cold enough point on the arc tube gives the opportunity to use the mercury dosing which has better run up.

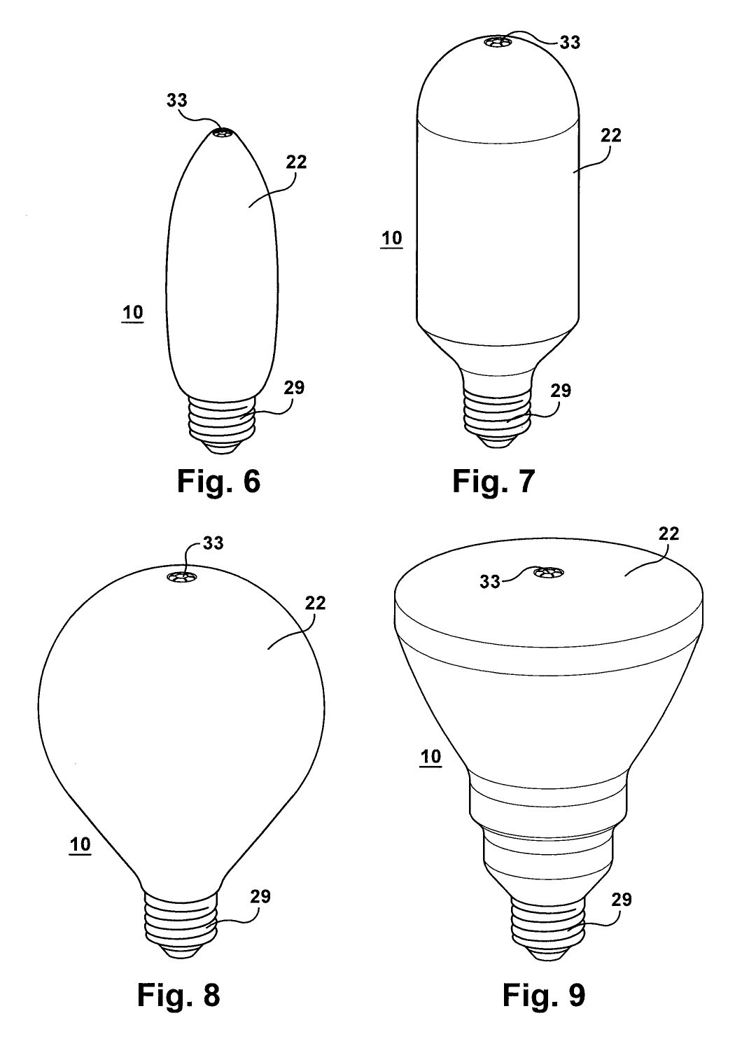

The outer envelope used in the lamp of this disclosure may have various shapes. For example, the outer envelope may have a candle shape as in FIG. 6, a bullet shape as in FIG. 7, a globe shape as in FIG. 8 or a reflector shape as in FIG. 9.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. A fluorescent lamp comprising
an arc tube comprised of light transmissive material;
a discharge sustaining fill sealed in the interior of said arc tube;
electrodes disposed in the sealed interior of said arc tube;
an outer envelope disposed around and spaced apart from said arc tube, said outer envelope including an opening;
wherein said arc tube includes a hollow protrusion that extends adjacent or into said opening.

2. The fluorescent lamp of claim 1 comprising a cap that fits into said opening into contact with said outer envelope.

3. The fluorescent lamp of claim 1 wherein said protrusion has an interior that communicates with the interior of said arc tube.

4. The fluorescent lamp of claim 1 wherein said protrusion is tubular and has an outer diameter that is ⅓ or less of a diameter of said arc tube.

5. The fluorescent lamp of claim 1 whereby positioning of said protrusion in said opening forms a cold spot of said arc tube at the protrusion, wherein said cold spot is maintained at a temperature of not more than 80° C. during operation of said lamp.

6. The fluorescent lamp of claim 1 wherein said discharge sustaining fill includes mercury or a mercury substitute and an inert gas selected from the group consisting of argon, krypton, neon and combinations thereof.

7. The fluorescent lamp of claim 1 wherein said arc tube and said protrusion are comprised of glass.

8. The fluorescent lamp of claim 1 wherein said protrusion does not directly touch said outer envelope.

9. The fluorescent lamp of claim 1 wherein said arc tube is a compact fluorescent lamp.

10. The fluorescent lamp of claim 9 wherein said outer envelope is in a shape of a conventional incandescent light bulb, candle, globe, capsule or reflector.

11. The fluorescent lamp of claim 10 wherein said arc tube is in a shape of a spiral or fingers.

12. The fluorescent lamp of claim 9 comprising a base attached to said outer envelope including external electrical contacts that are in electrical contact with said electrodes, wherein said protrusion is disposed at a location of said outer envelope that is distal from said base.

13. The fluorescent lamp of claim 6 wherein said mercury is in the form of a liquid or a solid pellet at room temperature and can be free mercury or a mercury alloy.

14. A fluorescent lamp comprising
an arc tube of a compact fluorescent lamp comprised of glass;
a discharge sustaining fill sealed in the interior of said arc tube;
electrodes disposed in the sealed interior of said arc tube;
an outer envelope disposed around and spaced apart from said arc tube, said outer envelope including an opening, said outer envelope being in a shape of a conventional incandescent light bulb;
wherein said arc tube includes a hollow protrusion comprised of glass which extends adjacent or into said opening, whereby positioning of said protrusion adjacent or into said opening forms a cold spot of said arc tube at the protrusion.

15. The fluorescent lamp of claim 14 wherein said arc tube is in a shape of a spiral or fingers.

16. The fluorescent lamp of claim 14 wherein said protrusion is tubular and has an outer diameter that is ⅓ or less than a diameter of said arc tube.

17. The fluorescent lamp of claim 14 wherein said protrusion does not directly touch said outer envelope.

18. The fluorescent lamp of claim 14 comprising a cap that fits into said opening into contact with said outer envelope.

19. The fluorescent lamp of claim 14 wherein said protrusion has an interior that communicates with the interior of said arc tube.

20. The fluorescent lamp of claim 14 wherein said cold spot is maintained at a temperature of not more than 80° C. during operation of said lamp.

21. The fluorescent lamp of claim 14 wherein said discharge sustaining fill comprises mercury or a mercury substitute and an inert gas selected from the group consisting of argon, krypton, neon and combinations thereof.

22. The fluorescent lamp of claim 14 comprising a base attached to said outer envelope including external electrical contacts that are in electrical contact with said electrodes, wherein said protrusion is disposed at a location of said outer envelope that is distal from said base.

23. The fluorescent lamp of claim 21 wherein said mercury is in the form of a liquid or a solid pellet at room temperature and can be free mercury or a mercury alloy.
